(19) United States
(12) Patent Application Publication
(10) Pub. No.: US 2009/0156238 A1
(43) Pub. Date: Jun. 18, 2009

(54) USER-FRIENDLY OVER-THE-AIR PERSONALIZATION PROCESS FOR MOBILE TELEPHONE/PROXIMITY PAYMENT DEVICE

(76) Inventor: Theresa L. Smith, St. Albans (GB)

Correspondence Address: BUCKLEY, MASCHOFF & TALWALKAR LLC, 50 LOCUST AVENUE, NEW CANAAN, CT, 06840, US

(21) Appl. No.: 11/958,695

(22) Filed: Dec. 18, 2007

(51) Int. Cl. H04Q 7/32

(52) U.S. Cl. 455/466; 455/566

(57) ABSTRACT

A method of operating a mobile telephone includes receiving a message in the mobile telephone and opening the message. Then a first screen display is presented by the mobile telephone. The first screen display provides an option for commencing the loading of a contactless payment function in the mobile telephone. The method further includes receiving an indication that the user selects the option, then displaying a second screen display. The second screen display permits the user to enter a verification code. User input to enter the verification code is then received. A payment card account number is loaded into the mobile telephone in response to receiving the verification code.

### BACKGROUND

Payment cards such as credit or debit cards are ubiquitous. For decades, such cards have included a magnetic stripe on which the relevant account number is stored. To consummate a purchase transaction with such a card, the card is swiped through a magnetic stripe reader that is part of a point of sale (POS) terminal. The reader reads the account number from the magnetic stripe. The account number is then used to route a transaction authorization request that is initiated by the POS terminal.

In pursuit of still greater convenience and more rapid transactions at POS terminals, payment cards have more recently been developed that allow the account number to be automatically read from the card by radio frequency communication between the card and a so-called “proximity reader” which may be incorporated with the POS terminal. In such cards, often referred to as “proximity payment cards” or “contactless payment cards”, a radio frequency identification (RFID) integrated circuit (IC, often referred to as a “chip”) is embedded in the card body. A suitable antenna is also embedded in the card body and is connected to the RFID chip to allow the chip to receive and transmit data by RF communication via the antenna. In typical arrangements, the RFID chip is powered from an interrogation signal that is transmitted by the proximity reader and received by the card antenna.

MasterCard International Incorporated, the assignee hereof, has established a widely-used standard, known as “PayPass”, for interoperability of proximity payment cards and proximity readers.

It has been proposed that the capabilities of a contactless payment card be incorporated into a mobile telephone, thereby turning the mobile telephone into a contactless payment device. One issue that is raised by this proposal is how to load the payment card account number and other account- or device-specific information into the mobile telephone; this process is referred to as “personalization”. As a result of their form factor, mobile telephones cannot be readily subjected to the same kind of automated personalization process that contactless payment cards typically undergo. It also may present logistical problems to transport a mobile telephone/contactless payment device to a personalization facility either after the user has purchased the phone, or before placing the phone in a typical mobile telephone distribution channel. It has therefore been proposed to personalize mobile telephone/contactless payment card devices while the devices are in the user's possession via “over the air” (OTA) data communication—i.e., by data communication via the mobile telephone network in which the phone operates.

OTA personalization processes for mobile telephones/contactless payment devices have been implemented on a trial basis, but the processes introduced up to this point have been rather burdensome and confusing for the user, and for that reason may well not be susceptible to successful large-scale adoption.

### BRIEF DESCRIPTION OF THE DRAWINGS

FIG. 1 is a schematic block diagram of a system that allows for OTA personalization of a mobile telephone.

FIG. 2 is a schematic block diagram of the mobile telephone shown in FIG. 1.

FIG. 3 is a flow chart that illustrates an embodiment of an OTA personalization process.

FIGS. 4-8 are examples of screen displays which may be displayed by the mobile telephone in the process of FIG. 3.

FIG. 9 is a flow chart that illustrates another embodiment of an OTA personalization process.

FIGS. 10-15 are examples of screen displays which may be displayed by the mobile telephone in the process of FIG. 9.

### DETAILED DESCRIPTION

In general, and for the purpose of introducing concepts of embodiments of the present invention, an OTA personalization process for a mobile telephone calls for the mobile telephone to provide a sequence of screen displays that minimize the number of inputs required from the user, and that keep the user informed about the progress of the personalization process.

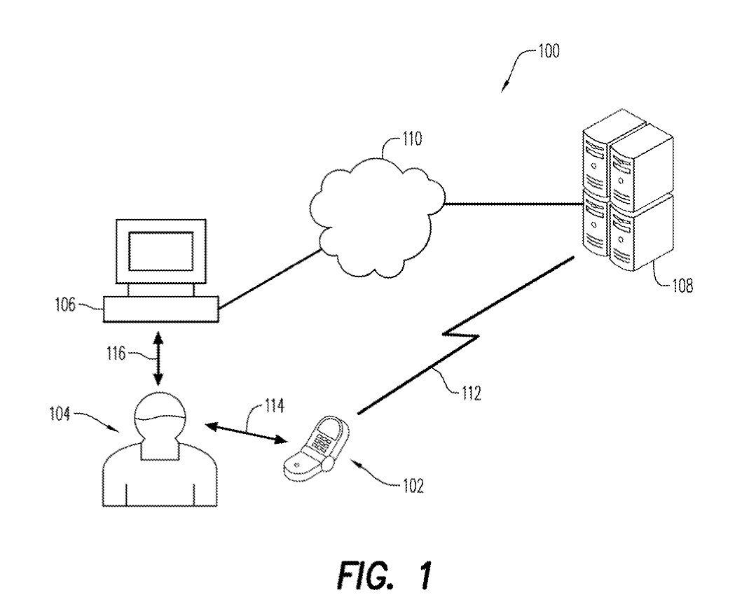

FIG. 1 is a schematic block diagram of a system 100 which allows for OTA personalization of a mobile telephone 102. The user/owner of the mobile telephone 102 is indicated at 104. The user's personal computer is indicated at 106. A server computer that manages the personalization process is indicated at 108. A communication network (e.g., the Internet), by which data communication is exchanged between the personal computer 106 and the server computer 108, is indicated at 110. It will also be understood that communication with the mobile telephone 102 occurs via a mobile telephone network, which is not explicitly shown in the drawing. Rather, the communication channel between the server computer 108 and the mobile telephone 102 is indicated at 112. In particular, SMS messaging and/or conventional client/server data communication may take place between the server computer 108 and the mobile telephone 102 via the communication channel 112.

Interaction between the user 104 and the mobile telephone 102 is schematically indicated at 114. Interaction between the user 104 and his/her personal computer 106 is schematically indicated at 116.

The personalization server 108, in some cases, may be operated by or on behalf of a bank or other financial institution that issued a payment card account to the user 104. Alternatively, the personalization server 108 may be operated by a service provider to which a number of different financial institutions may subcontract mobile telephone personalization services. For example, the service provider may be a payment card association, such as MasterCard International Incorporated.

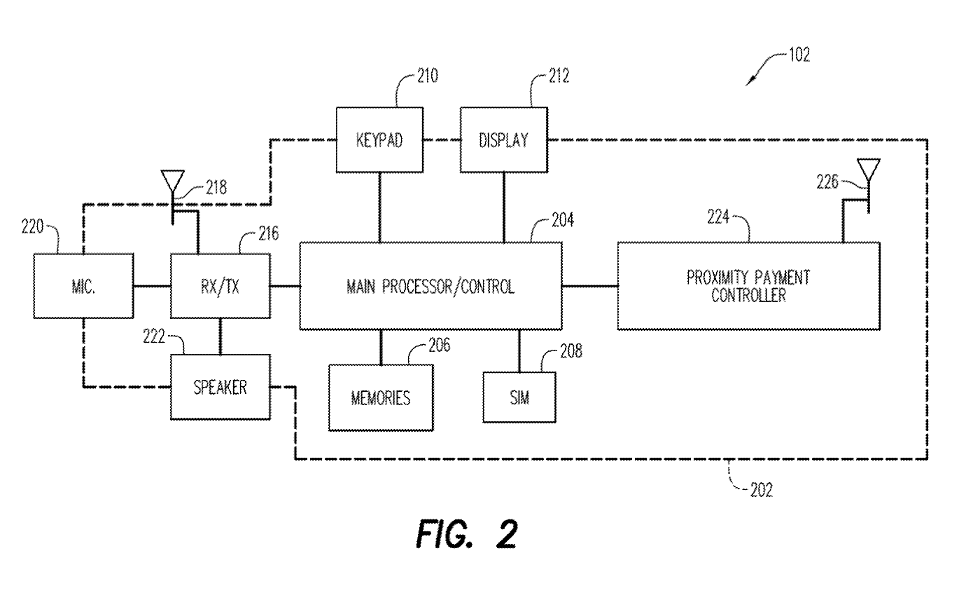

FIG. 2 is a block diagram of an example of the mobile telephone 102 shown in FIG. 1. In its hardware aspects the mobile telephone 102 may be entirely conventional, and indeed in most or all of its software aspects it also may be conventional, and may provide novel functionality as described herein through interaction (via a conventional browser and/or SMS messaging) with the personalization server 108. In other embodiments, however, novel functionality as described herein may result at least partially from software and/or firmware that programs the mobile telephone 102.

The mobile telephone 102 may include a conventional housing (indicated by dashed line 202) that contains and/or supports the other components of the mobile telephone 102. The mobile telephone 102 further includes conventional control circuitry 204, for controlling over-all operation of the mobile telephone 102. Preferably the control circuitry 204 is suitably programmed to allow the mobile telephone 102 to engage in data communications and/or text messaging with other devices, and to allow for interaction with web pages accessed via browser software, which is not separately shown. Other components of the mobile telephone 102, which are in communication with and/or controlled by the control circuitry 204, include: (a) one or more memory devices 206 (e.g., program and working memory, etc.); (b) a conventional SIM (subscriber identification module) card 208; (c) a conventional keypad 210 (or touch screen) for receiving user input; and (d) a conventional display 212 (or, again, touch screen) for displaying output information to the user.

The mobile telephone 102 also includes conventional receive/transmit circuitry 216 that is also in communication with and/or controlled by the control circuitry 204. The receive/transmit circuitry 216 is coupled to an antenna 218 and provides the communication channel(s) by which the mobile telephone 102 communicates via the mobile network (not shown). The mobile telephone 102 further includes a conventional microphone 220, coupled to the receive/transmit circuitry 216. Of course, the microphone 220 is for receiving voice input from the user. In addition, a loudspeaker 222 is included to provide sound output to the user, and is coupled to the receive/transmit circuitry 216.

The mobile telephone 102 may also include an integrated circuit (IC) or chipset 224 of the kind embedded in contactless payment cards. For example, the IC 224 is connected to an antenna 226 and (once the mobile telephone 102 has been personalized, as described below) operates so as to interact with an RFID/NFC proximity reader of a POS terminal to provide a payment card account number for a purchase transaction at the POS terminal. For example, the IC 224 may be designed/programmed to operate in accordance with the above-mentioned “PayPass” standard.

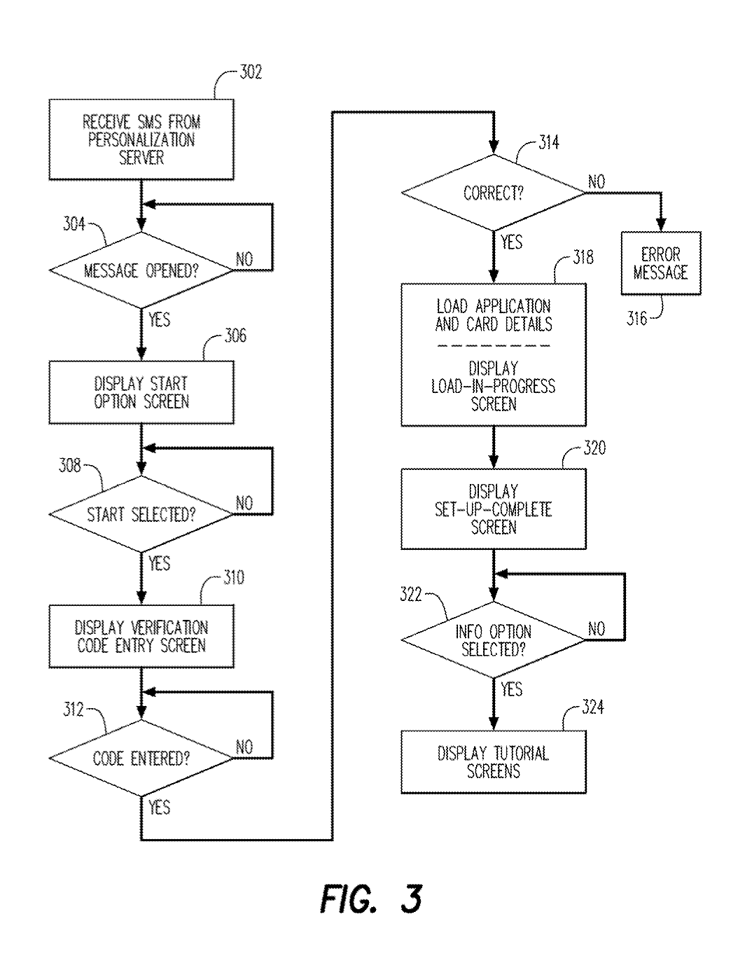

As a preliminary to the personalization process illustrated in FIG. 3, and referring again to FIG. 1, the user 104 may request personalization via his/her personal computer 106. In particular, the user may operate the PC 106 access a website maintained by the personalization server 108 and may enter, via the PC 106, his/her payment card account number and the mobile telephone number assigned to the mobile telephone 102. In addition, the user may enter identifying data (e.g., his/her name and address), security information (e.g., a PIN and/or a card security code printed on the back of his/her payment card) and/or other information requested by the personalization server 108. In response, the personalization server 108 may download a verification code to the user's PC 106. The verification code is displayed to the user by the PC 106 and, as seen below, is to be entered by the user into the mobile telephone 102 during the personalization process. (Alternatively, the user may select/input a verification code and upload the verification code to the personalization server 108.) In addition, the personalization server 108 sends an SMS message (or the like) to the mobile telephone 102 to allow the personalization process to commence.

Reference is now made to FIG. 3, which illustrates the personalization process as carried out in the mobile telephone 102.

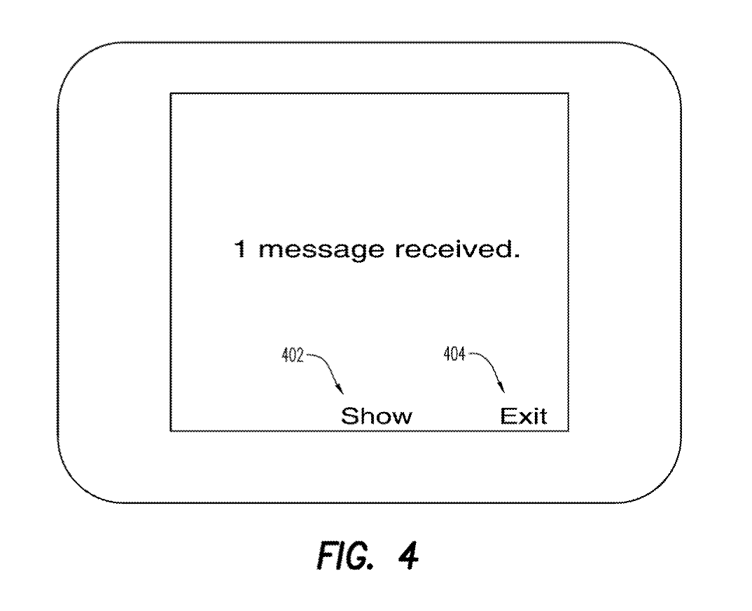

At 302 in FIG. 3, the mobile telephone 102 receives the SMS message sent by the personalization server 108, as referred to above. As a result, the display 212 of the mobile telephone 102 displays a screen display like that shown in FIG. 4, to indicate to the user that the SMS message has been received. The screen display of FIG. 4 may be referred to as a message-received screen display. It will be noted that the screen display of FIG. 4 presents the user with two (conventional) options, i.e.: (a) displaying the message (this option indicated by the word “Show”—reference numeral 402); or exiting to a main menu or home screen display (this option indicated by the word “Exit”—reference numeral 404). The user may select between these options by, e.g., actuating one of two soft keys (not separately shown) on the mobile telephone 102.

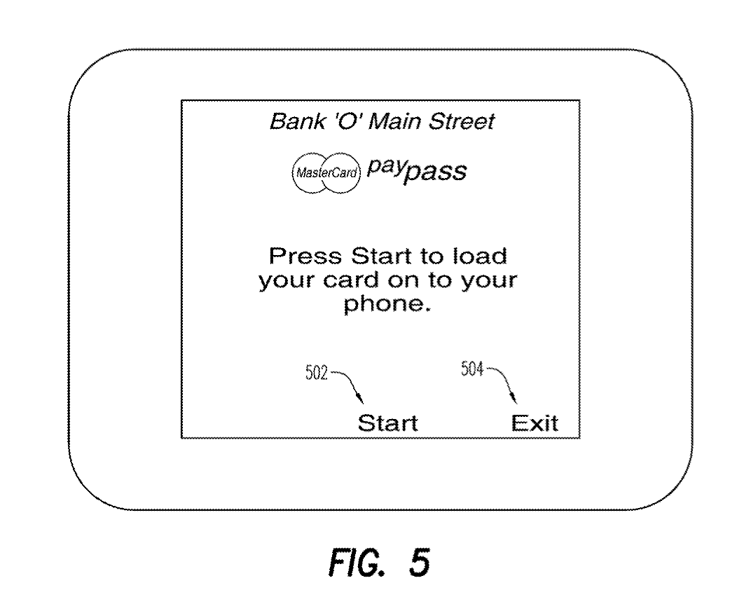

Referring again to FIG. 3, at 304 the mobile telephone 102 (e.g., via the control circuitry 204) determines whether the user has selected the “Show” option. (Not shown in the drawing is a decision block/process branch to implement the “exit” option.) If the user selects the “Show” option, then the display 212 of the mobile telephone 102 displays (step 306, FIG. 3) a screen display like that shown in FIG. 5, to indicate to the user that he/she may now initiate the personalization process. In particular, the user is presented with two options, either to start the personalization process (option indicated by the word “Start”—reference numeral 502) or to exit from the personalization process (option indicated by the word “Exit”—reference numeral 504). As before, in some embodiments the user may select between these options by actuating one of two soft keys on the mobile telephone 102.

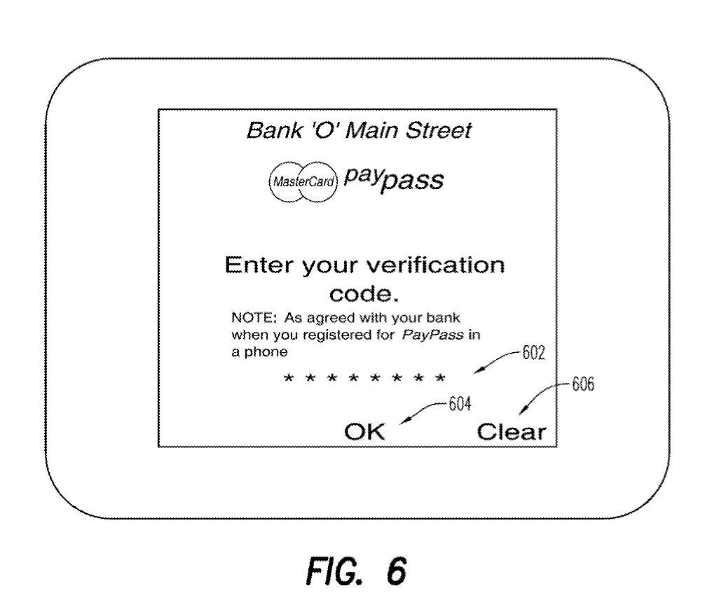

Referring once more to FIG. 3, at 308 the mobile telephone 102 (e.g., via the control circuitry 204) determines whether the user has selected the “Start” option. (Again the exit branch is omitted from the flow chart.) If the user selects the “Start” option then the display 212 of the mobile telephone 102 displays (step 310, FIG. 3) a screen display like that shown in FIG. 6. It will be observed that the screen display of FIG. 6 instructs the user to enter the verification code previously provided to the user by the personalization server 108 (or provided by the user to the personalization server 108). A field 602 is populated with asterisks as the user enters digits of the verification code. The user can confirm that entry of the verification code is complete by selecting an option indicated by the legend “OK” (reference numeral 604), or the user may elect to re-start entry of the verification code by selecting an option indicated by the legend “Clear” (reference numeral 606).

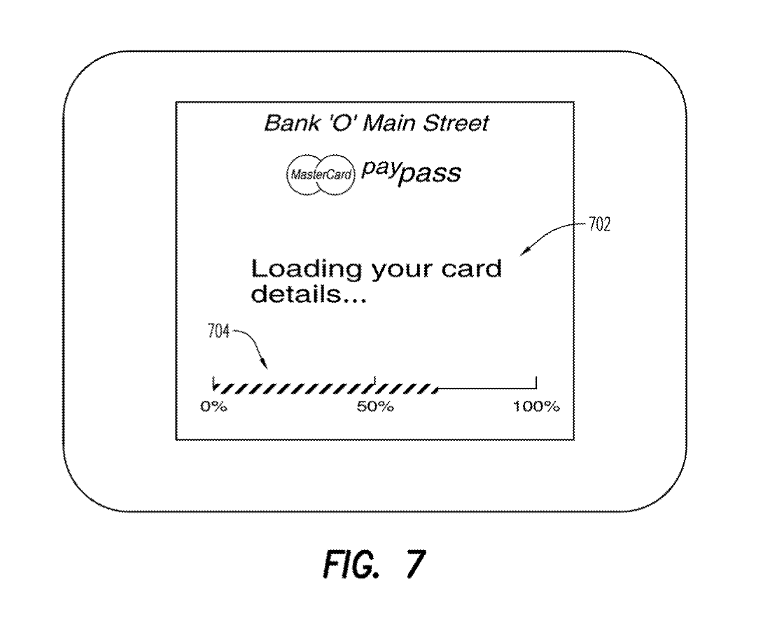

At 312 in FIG. 3, the mobile telephone 102 determines whether the user has indicated that entry of the verification code has been completed. (In a branch that is not indicated, the step for entry of the verification code may time out if not completed within a pre-determined amount of time.) If the user indicates completion of entry of the verification code, then the mobile telephone 102 may send the verification code to the personalization server 108 for verification that the code was correct. Thus, at 314, the mobile telephone 102 may await a message from the personalization server 108 that indicates correctness of the verification code. (Alternatively, the personalization server 108 may have downloaded the correct verification code to the mobile telephone 102, to allow the mobile telephone 102 to determine whether the verification code, as entered by the user, is correct.) If the code was not correct, then the mobile telephone 102 may display an error message (not shown), as indicated by step 316. If the code was correct, then step 318 may follow decision block 314. At 318, the mobile telephone 102 may receive from the personalization server 108 a download of the necessary application software and user-specific information (e.g., payment card account number, user-specific encryption key, etc.) required to set up the mobile telephone 102 to function as a contactless payment device with access to the user's payment card account. At the same time, the mobile telephone 102 may display a screen display like that shown in FIG. 7. The screen display of FIG. 7 may be referred to as a loading-in-progress screen display.

The screen display of FIG. 7 provides text at 702 to indicate that the user's payment card account information is being loaded into the mobile telephone 102. The screen display of FIG. 7 also includes a progress bar 704 that graphically illustrates to what extent the current loading step has been completed.

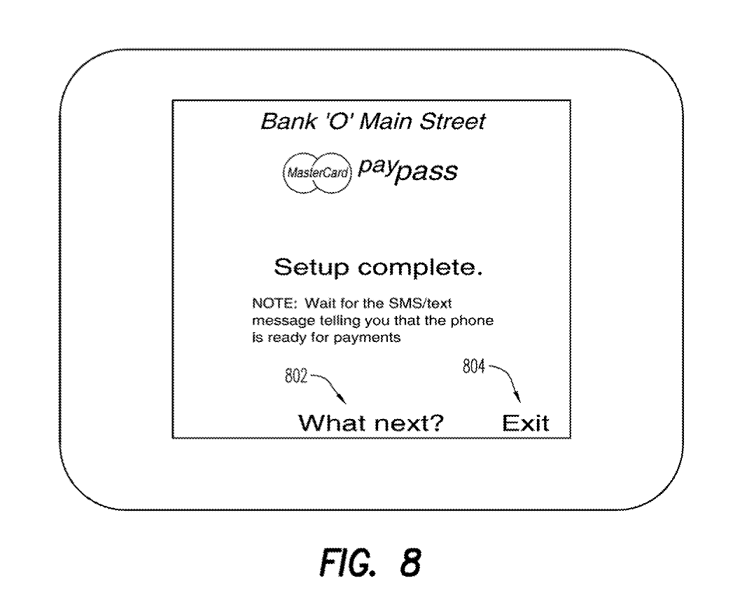

Upon completion of the loading of the contactless payment application and the user/device-specific information, step 320 follows step 318. At step 320, the mobile telephone 102 displays a screen display like that shown in FIG. 8. This screen display informs the user that the personalization process has been completed, as far as the user and the mobile telephone 102 are concerned, and that the user need only wait until another SMS message is received to indicate that the personalization server 108 has acknowledged completion of the personalization process. Thus the screen display of FIG. 8 may be referred to as a “set-up-complete” screen display.

The screen display may also present two options to the user, namely a “What next?” option (reference numeral 802) and an “Exit” option (reference numeral 804). As before, these options may be selected by actuating the soft keys.

Referring again to FIG. 3, at 322 the mobile telephone 102 determines whether the user has selected the “What next?” option 802. If so, then step 324 follows. At 324, the display 212 of the mobile telephone 102 may display one or more screen displays (not shown) that may provide a tutorial as to how the user may employ the mobile telephone 102 to make contactless payments. For example, the mobile telephone 102 may display a story board or an animation to indicate a user tapping his/her mobile telephone on a proximity reading unit of a POS terminal to cause the proximity reading unit to read the payment card account number stored in the mobile telephone.

(As before, the “exit” branch of the process has been omitted from the drawing.)

With the personalization process illustrated in FIGS. 3-8, the screen displays are clear, easy to understand, user-friendly and few in number, and the user is only required to take a minimum number of actions (opening the SMS message, electing to start the personalization process, and entering the verification code) in order to accomplish the personalization of the mobile telephone 102. Thus this process may be suitable for application in a mass market introduction of OTA personalization of mobile telephones to serve as contactless payment devices.

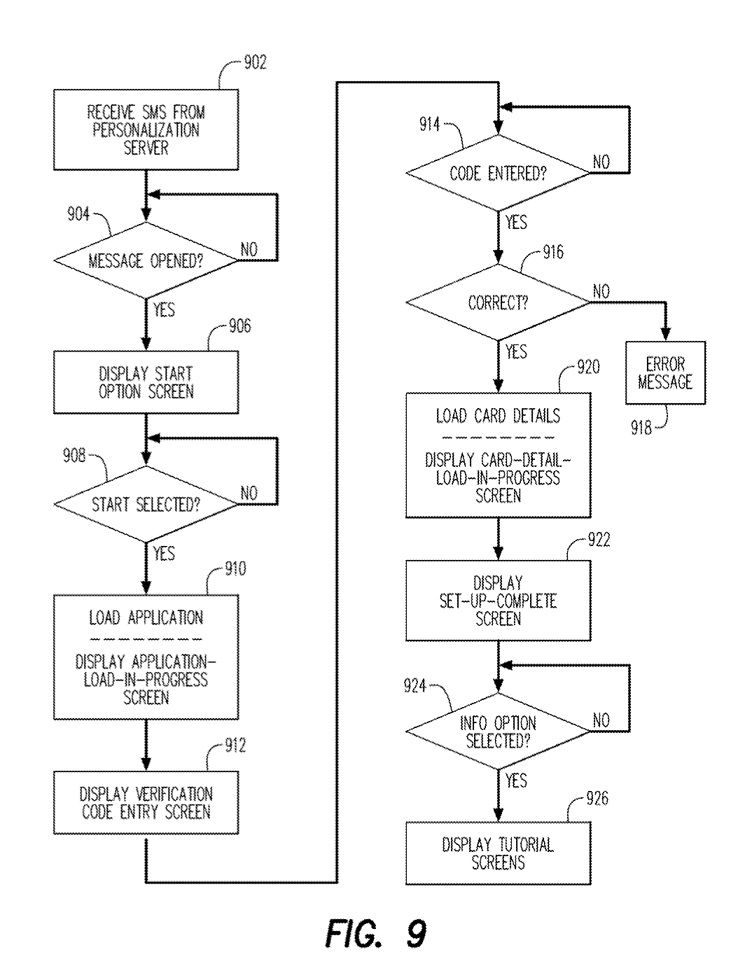

FIG. 9 is a flow chart that illustrates another embodiment of an OTA personalization process for the mobile telephone 102.

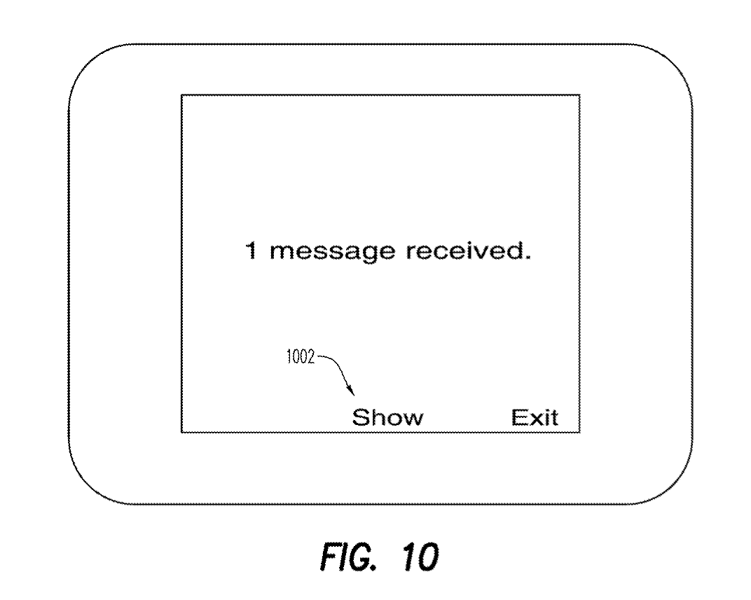

At 902 in FIG. 9, the mobile telephone 102 receives the SMS message sent by the personalization server 108, as referred to above. As a result, the display 212 of the mobile telephone 102 displays a screen display like that shown in FIG. 10. (Since this screen display is identical to that of FIG. 4, as described above, description of FIG. 10 is omitted.)

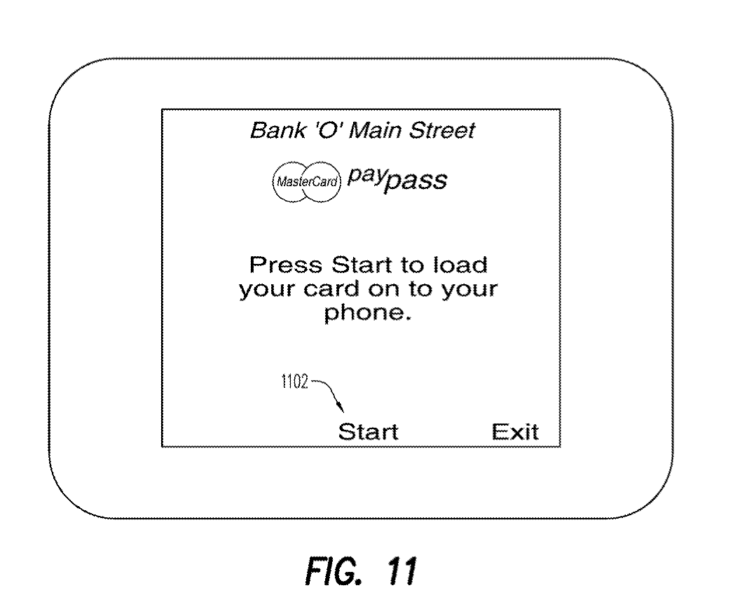

At 904 in FIG. 9, mobile telephone 102 determines whether the user has selected the “Show” option (reference numeral 1002 in FIG. 10). If so, then the display 212 of the mobile telephone 102 displays (906 in FIG. 9) a screen display like that shown in FIG. 11. (Since the screen display of FIG. 11 is identical to that of FIG. 5, and serves the same purpose, description of FIG. 11 is omitted.)

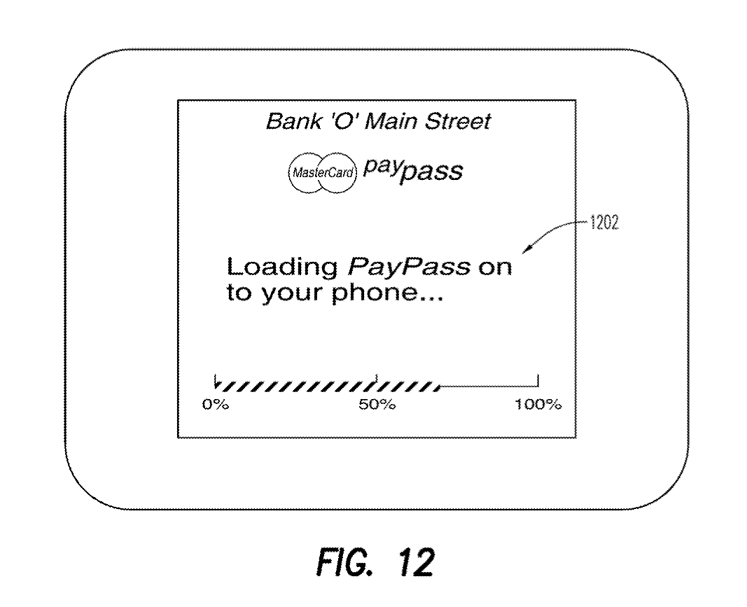

At 908 in FIG. 9, mobile telephone 102 determines whether the user has selected the “Start” option (reference numeral 1102 in FIG. 11). If so, then a signal to that effect may be sent from the mobile telephone 102 to the personalization server 108, which may respond by downloading to the mobile telephone 102 the necessary application software required to enable contactless payment functionality in the mobile telephone 102. (Step 910 in FIG. 9 represents the mobile telephone 102 receiving this download.) At the same time, the display 212 of the mobile telephone 102 displays a screen display like that shown in FIG. 12. The screen display of FIG. 12 informs the user (via text indicated by reference numeral 1202 in FIG. 12) that an application program to enable contactless payment is being loaded into the mobile telephone 102. The screen display of FIG. 12 also includes a progress bar 1204 that graphically illustrates to what extent the current loading step has been completed. The screen display of FIG. 12 may be referred to as an application-load-in-progress screen display.

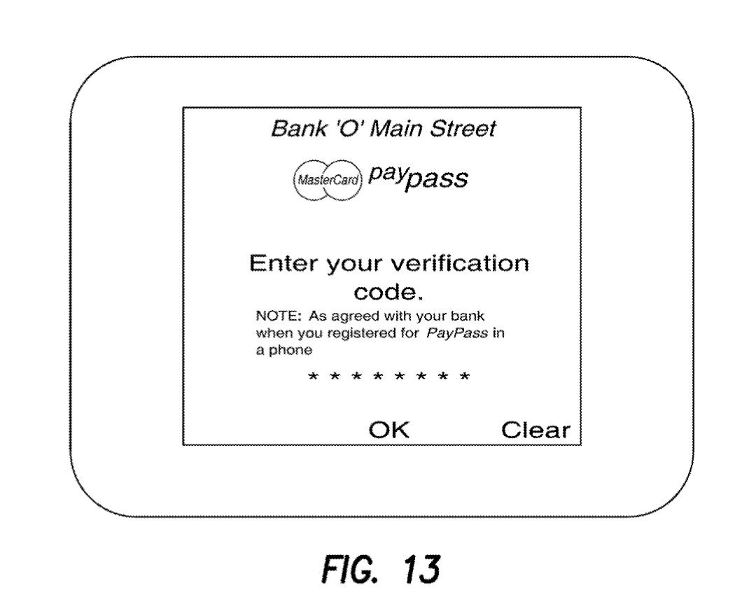

Upon completion of the loading of the contactless payment application, step 912 follows step 910. At step 910, the display 212 of the mobile telephone 102 displays a screen display like that shown in FIG. 13. (It is noted that the screen display of FIG. 13 is identical to that shown in FIG. 6. Since FIG. 6 is described above, it is believed that description of FIG. 13 would be redundant.)

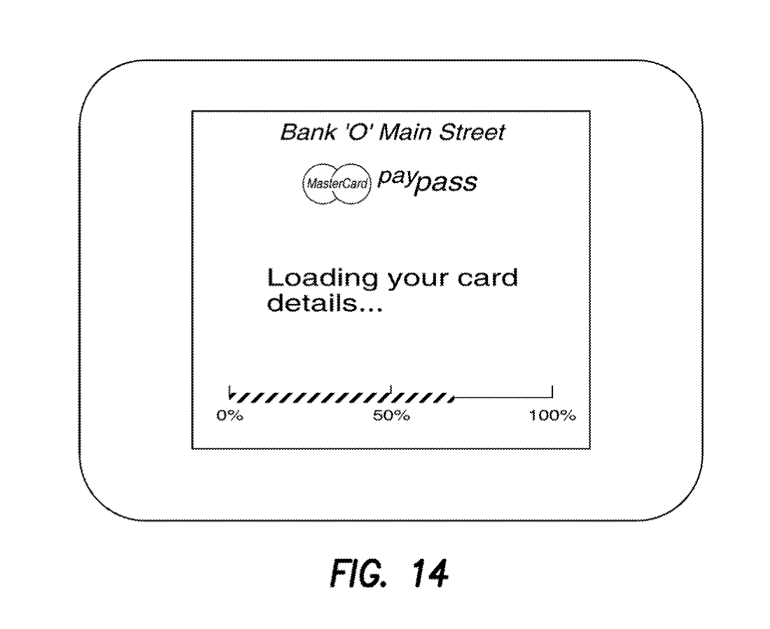

At 914 in FIG. 9, the mobile telephone 102 determines whether the user has indicated that entry of the verification code has been completed. (In a branch that is not indicated, the step for entry of the verification code may time out if not completed within a pre-determined amount of time.) If the user indicates completion of entry of the verification code, then the mobile telephone 102 may send the verification code to the personalization server 108 for verification that the code was correct. Thus, at 916, the mobile telephone 102 may await a message from the personalization server 108 that indicates correctness of the verification code. (Or, as in the process of FIG. 3, the verification code may have been downloaded to the mobile telephone 102, to allow the mobile telephone 102 to determine whether the user correctly entered the verification code.) If the code was not correct, then the mobile telephone 102 may display an error message (not shown), as indicated by step 918. If the code was correct, then step 920 may follow decision block 916. At 920, the mobile telephone 102 may receive from the personalization server 108 a download of the user-specific information (e.g., payment card account number, user-specific encryption key, etc.) required to complete set up of the mobile telephone 102 to function as a contactless payment device with access to the user's payment card account. At the same time, the mobile telephone 102 may display a screen display like that shown in FIG. 14. (It will be noted that the screen display of FIG. 14 is identical to that shown in FIG. 7. FIG. 14 therefore need not be described, except to note that its effective function is slightly different from FIG. 7 in that FIG. 14 only informs the user of the progress of the downloading of user-specific information, instead of covering downloading of both the application program and the user-specific information, as may be the case with FIG. 7.)

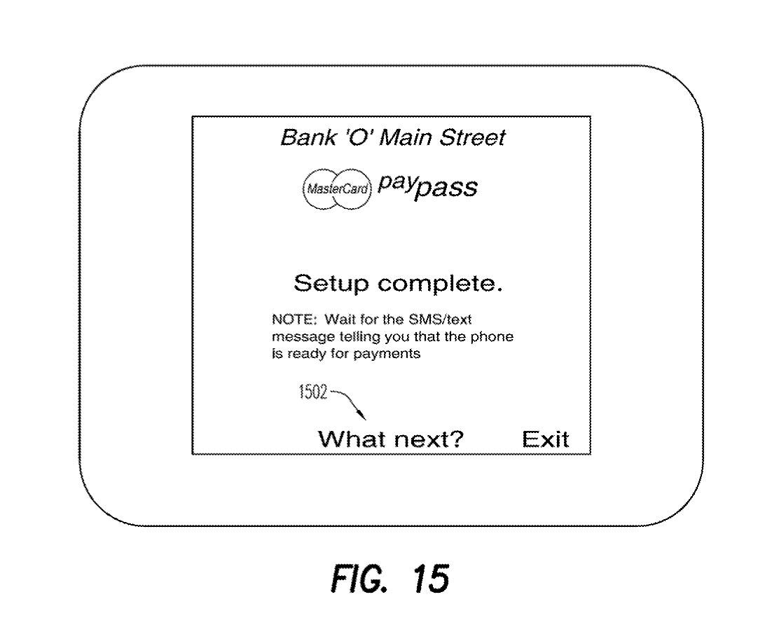

Upon completion of the loading of the user/device-specific information, step 922 follows step 920. At step 922, the mobile telephone 102 displays a screen display like that shown in FIG. 15. (This screen display is identical to that shown in FIG. 8, and therefore need not be further described.)

Referring again to FIG. 9, at 924 the mobile telephone 102 determines whether the user has selected the “What next?” option 1502 shown in FIG. 15. If so, then step 926 follows. At 926, the display 212 of the mobile telephone 102 may display one or more screen displays (not shown) that may provide a tutorial as to how the user may employ the mobile telephone 102 to make contactless payments. (An example tutorial was described above in connection with 324 in FIG. 3.)

(As was the case with FIG. 3, “exit” branches are omitted from FIG. 9 as not being essential to presentation of the process.)

The process of FIG. 9 requires exactly the same actions from the user as the process of FIG. 3; however, one more screen display is included to reflect that in the process of FIG. 9 the application load may occur before entry and verification of the verification code, rather than after as in the process of FIG. 3. Nevertheless, like the process of FIG. 3, the process of FIG. 9 provides a user experience that is simple, concise and straightforward, and therefore suitable for use in a large-scale introduction of OTA personalization for mobile telephone/contactless payment devices.

Where actions are described above as undertaken by the mobile telephone 102, it should be understood that such actions may be effected by either or both of the control devices 204, 224 shown in FIG. 2. Where displaying of screen displays is referred to above, this should be understood to possibly entail displaying of such screen displays via the display 212 shown in FIG. 2. The screen displays shown in the drawings may be generated by an application program in the mobile telephone 102 or may be downloaded from the personalization server 108.

In some embodiments, the application program for contactless payment functionality may be loaded into the mobile telephone at the factory, or otherwise may be resident in the mobile telephone prior to personalization; in such embodiments, loading of the application into the phone may be omitted from the OTA personalization process.

The above description and/or the accompanying drawings are not meant to imply a fixed order or sequence of steps for any process referred to herein; rather any process may be performed in any order that is practicable, including but not limited to simultaneous performance of steps indicated as sequential.

Although the present invention has been described in connection with specific exemplary embodiments, it should be understood that various changes, substitutions, and alterations apparent to those skilled in the art can be made to the disclosed embodiments without departing from the spirit and scope of the invention as set forth in the appended claims.

What is claimed is:

1. A method of operating a mobile telephone, the method comprising:
receiving a message in the mobile telephone;
opening the message in the mobile telephone;
in response to opening the message, displaying a first screen display, the first screen display for presenting, to a user of the mobile telephone, an option to commence loading a contactless payment function into the mobile telephone;
receiving an indication that the user selects said option;
in response to receiving said indication, displaying a second screen display, the second screen display for permitting the user to enter a verification code;
receiving input from the user to enter the verification code; and
in response to receiving said input, loading a payment card account number into the mobile telephone.

2. The method of claim 1, wherein no action by the user is required to enable the contactless payment function in the mobile telephone, other than (a) said opening the message; (b) providing said indication; and (c) entering said verification code.

3. The method of claim 2, further comprising:
in response to receiving said input, loading an application program in said mobile telephone to enable the contactless payment function in the mobile telephone.

4. The method of claim 2, further comprising:
displaying a progress bar during said loading step.

5. The method of claim 2, further comprising:
after loading said payment card account number into the mobile telephone, displaying a set-up-complete screen display.

6. The method of claim 5, wherein the mobile telephone displays only five screen displays in connection with enabling the contactless payment function, the five screen displays consisting of: (1) a message-received screen display; (2) said first screen display; (3) said second screen display; (4) a loading-in-progress screen display; and (5) said set-up-complete screen display.

7. The method of claim 5, wherein said set-up-complete screen display includes an option for the user to select to receive information concerning how to use the contactless payment function.

8. The method of claim 1, wherein the message is an SMS message.

9. A method of operating a mobile telephone, the method comprising:
receiving a message in the mobile telephone;
opening the message in the mobile telephone;
in response to opening the message, displaying a first screen display, the first screen display for presenting, to a user of the mobile telephone, an option to commence loading a contactless payment function into the mobile telephone;
receiving an indication that the user selects said option;
in response to receiving said indication, loading an application program in said mobile telephone to enable the contactless payment function in the mobile telephone;
during said loading step, displaying a second screen display, said second screen display indicating that said loading is in progress;
after displaying said second screen display, displaying a third screen display, said third screen display for permitting the user to enter a verification code;
receiving input from the user to enter the verification code; and
in response to receiving said input, loading a payment card account number into the mobile telephone.

10. The method of claim 9, wherein no action by the user is required to enable the contactless payment function in the mobile telephone, other than (a) said opening the message; (b) providing said indication; and (c) entering said verification code.

11. The method of claim 10, wherein said second screen display includes a progress bar.

12. The method of claim 10, further comprising:
displaying a fourth screen display during said loading of said payment card account number, said fourth screen display indicating that said loading of said payment card account number is in progress.

13. The method of claim 12, wherein said fourth screen display includes a progress bar.

14. The method of claim 12, further comprising:
after loading said payment card account number into the mobile telephone, displaying a set-up-complete screen display.

15. The method of claim 14, wherein the mobile telephone displays only six screen displays in connection with enabling the contactless payment function, the six screen displays consisting of: (1) a message-received screen display; (2) said first screen display; (3) said second screen display; (4) said third screen display; (5) said fourth screen display; and (6) said set-up-complete screen display.

16. The method of claim 14, wherein said set-up-complete screen display includes an option for the user to select to receive information concerning how to use the contactless payment function.

17. The method of claim 9, wherein the message is an SMS message.
